(19) United States
(12) Patent Application Publication
(10) Pub. No.: US 2026/0369746 A1
(43) Pub. Date: Nov. 19, 2026

(54) ELECTROLYTE SURFACTANT COMPOSITIONS FOR METAL AIR AND ALKALINE BATTERIES

(71) Applicant: Energizer Brands, LLC, St. Louis, MO (US)

(72) Inventors: Richard John Szczepaniak II, Liberty Township, OH (US); Mitchell Sean Rosiejka, Hudson, WI (US); John George Kania, Middleton, WI (US)

(73) Assignee: Energizer Brands, LLC, St. Louis, MO (US)

(21) Appl. No.: 19/124,198

(22) PCT Filed: Nov. 7, 2023
(86) PCT No.: PCT/US2023/078880

§ 371 Date: Apr. 24, 2025

Related U.S. Application Data
(60) Provisional application No. 63/423,953, filed on Nov. 9, 2022.

(51) Int. Cl. H01M 12/02; H01M 12/06; H01M 12/08

(52) U.S. Cl. CPC H01M 12/02; H01M 12/06; H01M 12/08

(57) ABSTRACT

A metal-air battery may include an air cathode, a metal anode, and an electrolyte comprising a surface-modifying surfactant. An electrolyte for a metal-air battery may include a surface-modifying surfactant, wherein the surface-modifying surfactant may include a polyethylene glycol (PEG), a mono-alkyl polyethylene glycol or a combination thereof.

### CROSS-REFERENCE TO RELATED PATENT APPLICATIONS

This application claims the benefit of and priority to U.S. Provisional Application No. 63/423,953, filed on Nov. 9, 2022, the entire disclosure of which is hereby incorporated by reference herein.

### FIELD

The present technology is generally related to the field of electrochemical cells. In particular, the technology is related to electrolytes for electrochemical cells, the electrolytes containing surface-modifying surfactants that improve the cell discharge capacity.

### SUMMARY

In one aspect, an electrolyte for an electrochemical cell is provided including an electrolyte comprising a surface-modifying surfactant, wherein the surface-modifying surfactant includes a polyethylene glycol (PEG), a mono-alkyl polyethylene glycol (mPEG) or a combination thereof. In at least one embodiment, the electrochemical cell includes a metal-air battery. In at least one embodiment, the metal-air battery includes a zinc-air battery. In at least one embodiment, the electrochemical cell includes an alkaline electrochemical cell.

In another aspect, a metal-air battery is provided including an air cathode, a metal anode, and an electrolyte, wherein the electrolyte includes a surface-modifying surfactant. In at least one embodiment, the surfactant includes a polyethylene glycol (PEG), a mono-alkyl polyethylene glycol or a combination thereof. In any embodiment, the metal-air battery further includes a separator between the air cathode and the metal anode.

In some embodiments, combinable with other aspects and embodiments, the surfactant includes a mono-alkyl polyethylene glycol. In at least one embodiment, the alkyl of the mono-alkyl polyethylene glycol is methyl, ethyl, propyl, n-butyl, or hexyl. In at least one embodiment, the surfactant includes methyl-polyethylene glycol. In at least one embodiment, the surfactant includes polyethylene glycol.

In any of the above embodiments, combinable with other aspects and embodiments, the electrolyte includes from about 10 ppm to about 15,000 ppm of the surface-modifying surfactant. In at least one embodiment, the electrolyte includes from about 10 ppm to about 2,000 ppm of methyl-polyethylene glycol. In at least one embodiment, the electrolyte includes from about 1,000 to about 10,000 ppm of polyethylene glycol.

In some embodiments, combinable with other aspects and embodiments, the electrolyte further includes a gas-suppressant additive. In at least one embodiment, the gas-suppressant additive includes lithium hydroxide, calcium hydroxide, aluminum hydroxide, zinc oxide, lead acetate, bismuth oxide, or a combination of any two or more thereof. In at least one embodiment, the gas-suppressant additive includes lithium hydroxide. In at least one embodiment, the electrolyte includes from about 1,000 to about 30,000 ppm of the gas-suppressant additive. In at least one embodiment, the electrolyte includes from about 15,000 to about 20,000 ppm of lithium hydroxide.

In some embodiments, combinable with other aspects and embodiments, electrolyte further includes an amphoteric fluorosurfactant. In some embodiments, the amphoteric fluorosurfactant includes a partially fluorinated surfactant having a betaine functionality. In at least one embodiment, the amphoteric fluorosurfactant is selected from the group consisting of CHEMGUARD® S-111, CHEMGUARD® S-500, CAPSTONE® FS-50, CAPSTONE® FS-51, APFS-14, DYNAX DX3001, Zonyl® FSK, Zonyl® FS-500 or a combination of any two or more thereof.

In any of the above embodiments, combinable with other aspects and embodiments, the electrolyte includes from about 10 ppm to about 30000 ppm of the amphoteric fluorosurfactant. In any of the above embodiments, the electrolyte includes from about 100 ppm to about 10000 ppm of the amphoteric fluorosurfactant.

In some embodiments, combinable with other aspects and embodiments, electrolyte may further include additional surfactants. Illustrative surfactants include, but are not limited to, cetyltrimethylammonium bromide (CTAB), sodium dodecylbenzene sulfonate (SDBS), sodium dodecyl sulfate (SDS), Sodium hexametaphosphate (SHMP), lauryltrimethylammonium bromide, dodecyltrimethylammonium bromide, octyltrimethylammonium bromide, or a combination of any two or more thereof.

In any of the above embodiments, combinable with other aspects and embodiments, the electrolyte includes from about 10 ppm to about 30000 ppm of the additional surfactant. In any of the above embodiments, the electrolyte includes from about 100 ppm to about 10000 ppm of the additional surfactant.

In any of the above embodiments, combinable with other aspects and embodiments, the electrolyte further includes a corrosion inhibitor, a gelling agent, zinc oxide, potassium hydroxide, sodium hydroxide, polyacrylate polymer, or a combination of any two or more thereof.

In any of the above embodiments, combinable with other aspects and embodiments, the anode may include a surfactant system, a corrosion inhibitor, a gelling agent, a gas suppressant additive, potassium hydroxide, sodium hydroxide, cesium hydroxide, other functional additives, or a combination of any two or more thereof.

The foregoing summary is illustrative only and is not intended to be in any way limiting. In addition to the illustrative aspects, embodiments and features described above, further aspects, embodiments and features will become apparent by reference to the following drawings and the detailed description.

### BRIEF DESCRIPTION OF THE DRAWINGS

FIG. 1 is a cross-sectional, schematic view depicting an exemplary electrochemical cell of an embodiment of the present disclosure.

FIG. 2 is a plot showing a comparison of various electrolyte surfactants in the ANSI size 13 Hearing aid standard test, according to an embodiment of the present disclosure.

FIG. 3 is a plot showing a comparison of various electrolyte surfactants in the ANSI size 13 Hearing aid standard test, according to another embodiment of the present disclosure.

### DETAILED DESCRIPTION

Various embodiments are described hereinafter. It should be noted that the specific embodiments are not intended as an exhaustive description or as a limitation to the broader aspects discussed herein. One aspect described in conjunction with a particular embodiment is not necessarily limited to that embodiment and can be practiced with any other embodiment(s).

As used herein, “about” will be understood by persons of ordinary skill in the art and will vary to some extent depending upon the context in which it is used. If there are uses of the term which are not clear to persons of ordinary skill in the art, given the context in which it is used, “about” will mean up to plus or minus 10% of the particular term.

The use of the terms “a” and “an” and “the” and similar referents in the context of describing the elements (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the embodiments and does not pose a limitation on the scope of the claims unless otherwise stated. No language in the specification should be construed as indicating any non-claimed element as essential.

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified. As a non-limiting example, a reference to “X and/or Y” can refer, in one embodiment, to X only (optionally including elements other than Y); in another embodiment, to Y only (optionally including elements other than X); in yet another embodiment, to both X and Y (optionally including other elements).

Ratio, concentrations, amounts, and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, 5 to 40 wt % should be interpreted to include not only the explicitly recited limits of 5 to 40 wt %, but also to include sub-ranges, such as 10 wt % to 30 wt %, 7 wt % to 25 wt %, and so forth, as well as individual amounts, including fractional amounts, within the specified ranges, such as 15.5 w1%, 29.1 wt %, and 12.9 wt %, for example.

As used herein, the term “cationic fluorosurfactants” refers to fluorosurfactants containing cationic groups and/or groups able to be protonated into cationic groups. In some embodiments, the cationic fluorosurfactant comprises primary, secondary, tertiary, and/or quaternary amine groups.

As used herein, the term “anionic fluorosurfactants” refers to fluorosurfactants containing anionic groups and/or groups able to be deprotonated into anionic groups. In some embodiments, the anionic fluorosurfactant comprises carboxy group(s), sulfonic group(s), phosphate group(s), phosphonate group(s) or their corresponding salts.

As used herein, the term “amphoteric fluorosurfactant” refers to a fluorosurfactant containing at least one cationic group and at least one anionic group as defined above for cationic and anionic fluorosurfactants. Exemplary amphoteric fluorosurfactants include, but are not limited to CHEMGUARD® S-111 (a short-chain perfluoro-based amphoteric fluorosurfactant of the alkyl amine oxide type), CHEMGUARD® S-500 (short-chain perfluoro-based amphoteric fluorosurfactant), CAPSTONE® FS-50 (a betaine partially fluorinated surfactant), CAPSTONE® FS-51 (an amine oxide partially fluorinated surfactant), APFS-14 (an amphoteric, polyfluoroalkyl betaine surfactant), DYNAX DX3001 (an amphoteric fluorochemical surfactant of the perfluoroalkyl-betaine type), ZONYL® FSK (a sparingly water-soluble, ethoxylated nonionic fluorosurfactant), ZONYL® FS-500 (a betaine fluorinated amphoteric surfactant), or a combination of any two or more thereof. As used herein, the term “betaine functionality” refers to a neutral compound with a positively charged cationic functional group and a negatively charged functional group. In some embodiments, the cationic functional group may be a quaternary ammonium or phosphonium cation, which bears no hydrogen atom. In some embodiments, the negatively charged functional group may be a carboxylate group.

As used herein, the term “metal anode” refers to an anode that includes a metal or metal alloy as an anode active material. For example, the term “zinc anode” refers to an anode that includes zinc or zinc alloy as an anode active material.

As used herein, the term “ppm” means parts per million by weight, unless explicitly expressed otherwise.

The present disclosure is directed to improving the performance of electrochemical cells, such as metal-air electrochemical cells or alkaline electrochemical cells. Metal-air electrochemical cells or batteries operate by taking up oxygen from the surrounding air and reducing it at the cathode, and oxidizing a metal at the anode, thereby providing an electric current flow through an external circuit connected between the anode and the cathode. Metal-air batteries such as Zn-air battery are considered as one of the most promising candidates for next-generation batteries for energy storage due to safety, high energy density, and low cost. However, metal anodes use metal or metal alloy powders, which may be subjected to corrosion in the presence of air and alkaline electrolyte. One of the reasons for corrosion of the metal anode is the hydrogen evolution reaction (HER), which is also known as self-corrosion of the metal anode. Metals such as zinc can be thermodynamically unstable in alkaline solution, since they have a more negative reduction potential than hydrogen, leading to evolution of hydrogen gas. Along with causing corrosion, HER consumes the electrolyte and decreases the utilization efficiency of the metal. Thus, hydrogen evolution contributes to the coulombic efficiency loss during both charging and discharging processes. The corrosion significantly reduces the shelf life and decreases the capacity of the metal-air batteries and production of usable electrical current.

It has now been found that the use of specific type of surfactants, for example, surface-modifying surfactants, may be added to the electrolyte to modify the surface of the anode active materials such as metal-based particles. The electrolyte compositions and surface-modifying surfactants disclosed herein also provide for improvements in discharge capacity over the current and conventional surfactants being used in the metal air battery. Without being bound by theory, it is believed that this effect is provided by easy transfer of reactants and reaction products, as well as reduction in the hydrogen evolution reaction, thereby preserving the metal for later in discharge.

In one aspect, an electrochemical cell is provided including an anode, cathode and an electrolyte. Suitable electrochemical cells include, but are not limited to, metal-air electrochemical cells and alkaline electrochemical cells. Exemplary metals in metal-air electrochemical cells include, without limitation, zinc, lithium, aluminum, iron, magnesium and alloys thereof. Examples of metal-air cells may include 675 cells (PR44), 13 cells (PR48), 312 cells (PR41), and 10 cells (PR70). Examples of alkaline cells are commonly known as LR6 (AA), LR03 (AAA), LR14 (C) and LR20 (D). In certain embodiments, the electrochemical cells include metal-air batteries and alkaline-metal batteries. In certain embodiment, the electrochemical cell includes a metal-air battery. In certain embodiment, the electrochemical cell includes a zinc-air battery.

In one aspect, a metal-air battery includes a cathode, an anode active material, an electrolyte, and optionally a separator disposed between the anode and the cathode, wherein the electrolyte includes a surface-modifying surfactant. The metal-air battery is typically filled with an electrolyte solution, including an alkaline aqueous solution, between a cathode and a metal anode, and is optionally provided with an insulating porous separator to prevent direct short-circuiting between the air electrode and the metal anode.

The electrochemical cell may include an electrolyte. The electrolyte may have a high ionic conductivity. The electrolyte may be an alkaline electrolyte, such as aqueous solution of an alkali metal hydroxide, or a quaternary ammonium electrolyte. Examples of alkali metal hydroxide include potassium hydroxide, lithium hydroxide or sodium hydroxide solution, and the like or a combination of any two or more thereof. In some embodiments, the alkali metal hydroxide may be potassium hydroxide, sodium hydroxide, indium hydroxide, or a mixture of any two or more thereof. In some embodiments, the alkali metal hydroxide may include potassium hydroxide. In some embodiments, the alkali metal hydroxide may include sodium hydroxide.

The alkali metal hydroxide may be present in the electrolyte from about 10% to about 50%, by weight of the electrolyte. This may include from about 15% to about 45%, from about 20% to about 40%, from about 25% to about 35%, or from about 25% to about 30%, by weight of the electrolyte, and ranges between any two of these values or less than any one of these values. In any embodiment, the alkali metal hydroxide may be present in an amount of about 30% to about 40%, by weight of the electrolyte. For example, the concentration or content of hydroxide in the electrolyte may be from about 1 wt % to about 60 wt %. This includes from about 5 wt % to about 50 wt %, from about 10 wt % to about 45 wt %, from about 15 wt % to about 40 wt %, from about 20 wt % to about 35 wt %, and from about 25 wt % by weight to about 30 wt % by weight and ranges between any two of these values or less than any one of these values. In some embodiments, the electrolyte may have a hydroxide content from 20 wt % to 34 wt %. In some embodiments, the electrolyte may have a hydroxide content of less than about 60 wt %. This includes a hydroxide content of less than about 50 wt %, less than about 40 wt %, less than about 30 wt %, less than about 20 wt %, and less than about 10 wt %.

The electrolyte includes a surface-modifying surfactant. The surface-modifying surfactants help to modify the surface of the anode active materials such as metal-based particles, reduce the self-corrosion caused by hydrogen evolution reaction, and provide for improvements in discharge capacity. Suitable surface-modifying surfactants include, without limitation, polyalkylene glycols, alkyl polyalkylene glycols, polyethylene glycol methyl ether, polypropylene methyl ether, and polypropylene ethyl ether and derivatives thereof. Suitable polyalkylene glycols and derivatives thereof may include, without limitation, polymethylene glycol (PMG), polyethylene glycol (PEG), polypropylene glycol (PPG), polybutylene glycol (PBG) or a combination of any two or more thereof. Alkyl polyalkylene glycols and derivatives thereof may include mono- or di-alkyl polyalkylene glycols. The alkyl of the alkyl polyethylene glycol may include C₁-C₁₂ alkyl or C₁-C₆ alkyl groups, such as methyl, ethyl, propyl, n-butyl, hexyl, heptyl or octyl group. Suitable alkyl polyalkylene glycols and derivatives thereof may include, without limitation, methyl polymethylene glycol (mPMG), methyl polyethylene glycol (mPEG), methyl polypropylene glycol (mPPG), ethyl polymethylene glycol (ePMG), ethyl polyethylene glycol (ePEG), ethyl polypropylene glycol (ePPG), or a combination of any two or more thereof. In some embodiments, the surface-modifying surfactant includes polyethylene glycol (PEG), methyl polyethylene glycol (mPEG) or a combination thereof.

Molecular weights (weight-average) from about 100 to about 30,000 of polyalkylene glycols and alkyl polyalkylene glycols may be useful in the electrolyte compositions, with molecular weights from about 300 to about 20,000 utilized in some embodiments. Suitable molecular weight for the glycol surfactants include, without limitation, about 100 to about 30,000, about 200 to about 25,000, about 300 to about 20,000, about 400 to about 15,000, about 500 to about 10,000, or about 550 to about 5,000, and ranges between any two of these values or less than any one of these values. In some embodiments, the surface-modifying surfactant includes polyethylene glycol (PEG) having molecular weight of 300. In other embodiments, the surface-modifying surfactant includes polyethylene glycol (PEG) having molecular weight of 20,000. In some embodiments, the surface-modifying surfactant includes methyl polyethylene glycol (mPEG) having molecular weight of 550.

The amount of surface-modifying surfactant in the electrolyte may vary depending on the type of the surfactant and other components in the electrolyte. For example, the concentration of the surface-modifying surfactant in the electrolyte may range from about 1 ppm to about 20,000 ppm, including from about 10 ppm to about 15,000 ppm, about 50 ppm to about 10,000 ppm, about 100 ppm to about 5,000 ppm or about 500 ppm to about 3,000 ppm, about 1,000 ppm to about 2,000 ppm, and ranges between any two of these values or less than any one of these values. In some embodiments, the electrolyte includes from about 10 ppm to about 15,000 ppm of the surface-modifying surfactant. In any of the above embodiments, combinable with other aspects and embodiments, the electrolyte includes from about 1,000 ppm to about 10,000 ppm of the surface-modifying surfactant. In any of the above embodiments, the electrolyte includes from about 100 ppm to about 5,000 ppm of the surface-modifying surfactant. In any of the above embodiments, the electrolyte includes from about 100 ppm to about 3,000 ppm of the surface-modifying surfactant.

In addition to using the surface-modifying surfactants, the suppression of gas generation, e.g., hydrogen from HER, or carbon dioxide, in the electrochemical cell, can be further achieved through the addition of one or more additives to the electrolyte or to the cell itself. Suitable gas-suppressant additives may include, without limitation, lithium hydroxide, calcium hydroxide, aluminum hydroxide, zinc oxide, lead acetate, bismuth oxide, or a combination of any two or more thereof. When present, the gas-suppressant additive may be present in an amount from about 1% to about 10%, by weight of the electrolyte. This may include about 1% to about 8%, 1% to about 5%, about 1.5 to about 5%, or about 2 to about 5%, by weight of the electrolyte. In one embodiment, the gas-suppressant additive is present in an amount of about 1%, about 1.5%, about 2%, about 2.5%, about 3%, about 3.5%, or about 4%, by weight of the electrolyte, or ranges between and including any two of these values. The gas-suppressant additives provide other benefits that do not limit them to act as just as a gas suppressing additive. Thus, referring to a component as a “gas suppressing additive” does not limit them to only that particular function. For example, in the case of a zinc-air battery, the zinc oxide can regulate zinc surface passivation, and lithium hydroxide can allow longer duration access of the electrolyte mix to the anode by creating a porous deposit of zinc oxide anode.

In addition to the surface-modifying surfactant, the electrolyte may optionally include an amphoteric fluorosurfactant. Suitable amphoteric fluorosurfactants are described in Suitable amphoteric surfactants are disclosed in U.S. Pat. No. 10,320,041, the contents of which are relied upon and incorporated herein by reference in their entirety. In some embodiments, the amphoteric fluorosurfactant includes a partially fluorinated surfactant having a betaine functionality. For example, the amphoteric surfactant may include, without limitation, CHEMGUARD® S-111, CHEMGUARD® S-500, CAPSTONE® FS-50, CAPSTONE® FS-51, APFS-14, DYNAX DX3001, ZONYL® FSK, ZONYL¹“ ”' FS-500, or a combination of any two or more thereof. When present, the amphoteric fluorosurfactant may be included in the electrolyte from about 10 ppm to about 20,000 ppm. For example, the concentration of the amphoteric fluorosurfactant in the electrolyte may range from about 1 ppm to about 20,000 ppm, including from about 10 ppm to about 15,000 ppm, about 50 ppm to about 10,000 ppm, about 100 ppm to about 5,000 ppm or about 500 ppm to about 3,000 ppm, about 1,000 ppm to about 2,000 ppm, and ranges between any two of these values or less than any one of these values. In some embodiments, the amphoteric fluorosurfactant is present in the electrolyte from about 100 ppm to about 10,000 ppm. In another embodiment, the amphoteric fluorosurfactant concentration in the electrolyte is about 500 ppm to about 5,000 ppm.

The electrolyte may further include one or more additional surfactants. Suitable surfactants include, without limitation, cetyltrimethylammonium bromide (CTAB), sodium dodecylbenzene sulfonate (SDBS), sodium dodecyl sulfate (SDS), Sodium hexametaphosphate (SHMP), lauryltrimethylammonium bromide, dodecyltrimethylammonium bromide, octyltrimethylammonium bromide, to polyethylene glycol methyl ether, polypropylene methyl ether, and polypropylene ethyl ether, or a combination of any two or more thereof. The electrolyte may include from about 10 ppm to about 15,000 ppm of the additional surfactant. In some embodiments, the electrolyte includes from about 50 ppm to about 10,000 ppm of the additional surfactant. In other embodiments, the electrolyte includes from about 100 ppm to about 5,000 ppm of the additional surfactant.

The electrolyte may further include water and/or a solvent. The water content of the electrolyte can range from about 25% to about 99% by volume of the solvent component of the electrolyte.

The anode active material may include metal and the anode is referred to as a “metal anode.” In this regard, it is to be noted that, as used herein, anode “active material” may refer to a single chemical compound that is part of the discharge reaction at the anode of a cell and contributes to the cell discharge capacity, including impurities and small amounts of other moieties that may be present therein. Anode “active material” does not include current collectors, electrode leads, etc., that may contain or support the metal active material. Exemplary anode active materials include, but are not limited to a metal such as zinc, lithium, aluminum, iron, magnesium, and/or alloys thereof. In certain embodiments, the anode active material includes alloys of the metal with other metals. For example, in the case of a zinc-air battery, zinc alloys may include alloying elements intended to raise the overpotential for hydrogen evolution to minimize the generation of hydrogen within the anode. In some embodiments, the zinc may be alloyed with one or more metals selected from lead (Pb), indium (In) bismuth (Bi), calcium (Ca), magnesium (Mg), and aluminum (Al). Specific alloying agents may be selected based on the desired properties and performance. Some combinations of alloying materials may work better with zinc than others. In some embodiments, the alloying metal is bismuth. In some embodiments, the zinc alloy includes zinc, bismuth, and indium. In some embodiments, the zinc alloy includes zinc, bismuth, indium, and aluminum. In some embodiments, the zinc alloy includes zinc, lead, indium, and aluminum. In certain embodiments, the anode active material includes zinc particles. In certain embodiments, the anode active material includes zinc alloy particles.

The amount of various alloying agents can be varied depending on the desired properties. For example, the concentrations of the alloying agents may range from about 20 ppm to about 750 ppm, including from about 50 ppm to about 100 ppm, about 100 ppm to about 300 ppm, about 300 ppm to about 400 ppm or about 400 ppm to about 600 ppm, and ranges between any two of these values or less than any one of these values. In some embodiments, the alloying agent is present at a concentration of about 50 ppm to 550 ppm. In some embodiments, alloy materials may include from about 0.01% to about 0.5% by weight of an active agent alone, or in combination with, from about 0.005% to about 0.2% by weight of one or more alloying agent. In some embodiments, the alloy may include from about 400 ppm to about 600 ppm of lead, about 100 ppm to about 300 ppm of indium and about 50 ppm to about 100 ppm aluminum. In some embodiments, the alloy may include from about 0 ppm to about 200 ppm of lead, about 100 ppm to about 300 ppm of indium and about 50 ppm to about 100 ppm aluminum. In some embodiments, the alloy may include from about 50 ppm to about 450 ppm bismuth and about 50 ppm to about 450 ppm indium. Concentrations of components are specified based on the total metal weight in the anode.

The performance of the anode and the metal-air cell of the present technology can be further enhanced with the use of metal anode materials having a defined particle size distribution to provide in the anode a narrow distribution of similar metal particle sizes, thereby enhancing the diffusion paths for the hydroxide ions. In addition to improving diffusion properties, the particle size distributions also provide the porosity sites for the precipitation of metal oxide, thereby delaying anode passivation. This approach is effective for use in the anodes of metal air battery cells and can be used in combination with other improvements disclosed herein. A suitable metal particle size distribution may be one in which about 0% to about 1% by weight of the anode active material, relative to the total amount of anode active material has a particle size of less than about 75 microns, about 15% to about 35% by weight relative of the total metal or metal alloy has a particle size of from about 75 microns to about 125 microns, about 15% to about 35% by weight of the total metal or metal alloy has a particle size of from about 125 microns to about 150 microns, about 15% to about 35% by weight of the anode active material, relative to the total amount of anode active material has a particle size of from about 150 microns to about 180 microns, and about 15% to about 35% by weight of the anode active material, relative to the total amount of anode active material has a particle size of from about 180 microns to about 250 microns, and about 0% to about 1% by weight of the anode active material, relative to the total amount of anode active material has a particle size of greater than about 250 microns.

The electrolyte and/or the anode may optionally include a surfactant system, a corrosion inhibitor, a gelling agent, a gas suppressant additive, ionic conductivity enhancer, potassium hydroxide, sodium hydroxide, cesium hydroxide, other functional additives, or a combination of any two or more thereof. In some embodiments, the electrolyte and/or anode may include a corrosion inhibitor, a gelling agent, zinc oxide, potassium hydroxide, sodium hydroxide, polyacrylate polymer, or a combination of any two or more thereof. For example, the electrolyte and/or the anode, may further include a surfactant system (e.g., hexyl diphenyl oxide disulfonic acid, diethylenetriamine, octylphenoxypolyethoxyethanol, Igepal® CA-630, Triton® X-100), a corrosion inhibitor (e.g., indium hydroxide, polyaniline, clay, polyethylene glycol, polypropylene glycol, or lithium hydroxide), a gelling agent (e.g., polyacrylate polymer), a gas suppressing additive (e.g., zinc oxide, aluminum hydroxide, or calcium bromide), functional additives (e.g., boric acid, sodium borate, potassium borate, sodium stannate, potassium stannate), a clay additive (e.g., laponite, montmorillonite, bentonite, kaolinite, smectite, and), a flow aid (e.g., polytetrafluoroethylene (PTFE), and acrylate polymers) or a combination of any two or more thereof. The concentration of these additives, when included, may range from about 0.01 wt % to about 20 wt % based on the total weight of the electrolyte and/or the anode.

The metal-air battery includes an air-cathode. The air-cathode is not particularly limited as long as the electrode functions as a positive electrode in the metal-air battery. A variety of air electrodes in which oxide can be used as a positive electrode active material may be used. Suitable air-cathodes include metals having redox catalytic property such as platinum and nickel, catalyst materials, which include carbon based materials having redox catalytic property such as graphite, and inorganic oxides having redox catalytic property such as perovskite type oxide, manganese dioxide, nickel oxide, cobalt oxide, and spinel oxide. In some embodiments, the cathode can may be formed entirely of a metal or alloy having a hydrogen overvoltage similar to that of the cathode (as opposed to plating or cladding the can) so long as sufficient strength and ductility are available from the material selected. Materials in addition to nickel, having such hydrogen overvoltage properties, include, for example and without limitation, cobalt and gold. In some embodiments, such materials may be coated as one or more coating layers onto the core layer by, for example, plating, cladding, or other application processes. The materials which provide sufficient strength and ductility may also be used as single layer materials in place of the composite structure. Single layer materials comprehend CRS or other suitable material as a core layer.

In some embodiments, steel strip plated with nickel and nickel alloy may be used because of cost considerations, and because pre-plated steel strip, which generally requires no post-plating processes, is commercially available. The metal in the can is preferably both ductile enough to withstand the drawing process, and strong and rigid enough, to tolerate and otherwise withstand the cell crimping and closure process as well as to provide primary overall structural strength to the cell.

In some embodiments, cathode cans may be made of nickel-plated stainless steel. In another embodiment, materials for cathode cans include nickel-clad stainless steel; cold-rolled steel plated with nickel; INCONEL® (a non-magnetic alloy of nickel); pure nickel with minor alloying elements (e.g. Nickel 200 and related family of Nickel 200 alloys such as Nickel 201, etc.), all available from Huntington Alloys, or DURANICKEL® 301, available from Special Metals. In some embodiments, some noble metals may also find use as plating, cladding, or other coating for can metals, including covering steel strip plated with nickel, and mild steel strip subsequently plated with nickel after fabricating the can.

In some embodiments, where multiple layers are used (e.g., CRS) coated on opposing sides with nickel, the present disclosure contemplates additional (e.g. fourth, fifth, etc.) layers, either between the nickel and CRS, or with a nickel layer between the CRS and the additional layer(s). For example, gold, cobalt, or other excellent electrical conductor can be deposited on some or all of the outer surface of the cathode can (outside the nickel layer) after the can is drawn, or drawn and ironed. As an alternative, such fourth etc. layer can be, for example, a bond-enhancing layer between the CRS and the nickel.

The can may be fabricated using a typical raw material structure of NI/SST/NI as the sheet structure, such sheet structure is from about 0.002 inch to about 0.012 inch. This may include about 0.003 inch to about 0.010 inch or about 0.004 inch to about 0.006 inch. In some embodiments, the thickness is about 0.002 inch thick, about 0.003 inch thick, about 0.004 inch thick, about 0.005 inch thick, or about 0.006 inch thick. In some embodiments, the thickness is about 0.005 inch thick. In some embodiments, each of the nickel layers represents about 1% to about 10%, of the overall thickness of the metal sheet in such 3-layer structure. This may include about 1.5% to about 9%, about 2% to about 8%, about 2.5% to about 7%, or about 3% to about 6.5%, of the overall thickness of the metal sheet in such 3-layer structure. In some embodiments, each of the nickel layers represents about 2% to about 4%, of the overall thickness of the metal sheet in such 3-layer structure. In some embodiments, each of the nickel layers represents about 2%, of the overall thickness of the metal sheet in such 3-layer structure.

The metal-air battery may include a grommet/gasket between the air cathode and the metal anode.

The insulating gasket is positioned generally between the cathode can and the anode can. The insulating gasket may perform at least two primary functions. First, the insulating gasket serves as a closure for the cell, to prevent anode material and/or electrolyte from leaking from the cell between the outer surface of the side wall of the anode can and the inner surface of the side wall of the cathode can. Thus, the insulating gasket must possess adequate liquid sealing properties to prevent such leakage. Generally, such properties are available in a variety of resiliently deformable thermoplastic polymeric materials.

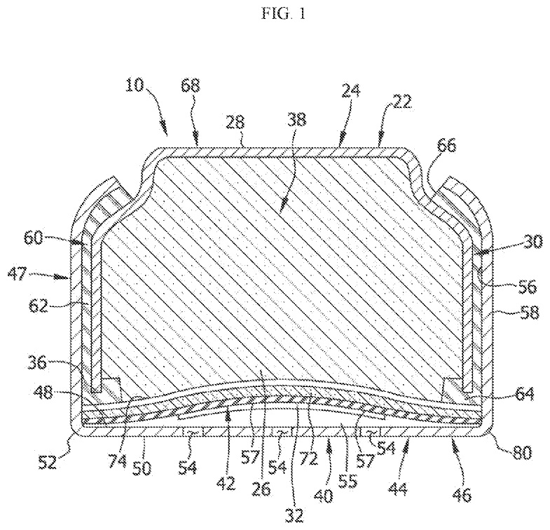

It is to be noted that the electrochemical cell of the present disclosure may be configured in accordance or consistent with metal air cell designs generally known in the art, such as zinc/silver oxide batteries, zinc/manganese dioxide batteries, etc., but for the design improvements provided in detail herein below. For example, in various embodiments the electrochemical cells of the present disclosure may be designed to specifications suitable for a button size battery. In particular, the electrochemical cell may be a metal air cell, such as a zinc-air button cell. In some embodiments, the shape of the cell is such that the anode is held in a somewhat flat or pan-shaped position. Accordingly, generally speaking, an exemplary embodiment of a cell of the present disclosure may be as illustrated in FIG. 1.

As illustrated in FIG. 1, referring specifically to the cell 10, the negative electrode contains the anode can assembly 22, with an anode can 24 including an electrochemically reactive anode 26 contained therein and an insulating gasket 60. The anode can 24 has a base wall 28, and circumferential downwardly-depending side wall 30. Side walls 30 terminate in a circumferential can foot 36. The base wall and side walls 30 generally define the anode cavity 38 within the anode can 24, which cavity contains the anode 26.

The positive electrode contains a cathode can assembly 40, which includes a cathode can 44 and the cathode 42. The cathode 42 comprises the area from below the separator 74 to the cathode can 44. This cathode 42 area includes the porous diffusion layer 57, the cellulose air diffusion layer and the cathode active layer 72. Active layer 72 ranges preferably between about 50 microns and about 1,250 microns thick, and facilitates the reaction between the hydroxyl ions in the electrolyte and the cathodic oxygen of the air. The separator 74 may include or consist of one or both of a micro-porous plastic membrane and a micro-porous cellulosic paper. The micro-porous plastic membrane is about 25 microns thick and typically composed of polypropylene. The paper material is 70-90 microns thick with a basis weight of 20 to 25 g/m2, and typically composed of polyvinyl alcohol and cellulosic material. The separator has the primary function of preventing anodic metal particles from coming into physical contact with the remaining elements of the cathode 42. The separator 74 however, does permit passage of hydroxyl ions and water therethrough to the cathode assembly. Here, the cathode is an air cathode and the cathode active layer includes carbon. Cathode can 44 has a bottom 46, and a circumferential upstanding side wall 47. Bottom 46 has a generally flat inner surface 48, a generally flat outer surface 50, and an outer perimeter 52 defined on the flat outer surface 50. A plurality of air ports 54 extend through the bottom 46 of the cathode can 44, providing avenues for traverse of oxygen through the bottom 46 into the adjacent cathode can assembly 40. An air reservoir 55 spaces the cathode can assembly 40 from bottom 46 and the corresponding air ports 54. A porous diffusion layer 57 and a cellulose air diffusion layer 32 fill the air reservoir 55. Side wall 47 of the cathode can has an inner surface 56 and an outer surface 58.

The anode can assembly 22 is electrically insulated from the cathode can assembly 40 by an insulating gasket 60. Insulating gasket 60 includes a circumferential side wall 62 disposed between the upstanding side wall 47 of the cathode can and the downwardly-depending side wall 30 of the anode can. An insulating gasket foot 64 is disposed generally between the can foot 36 of the anode can and the cathode can assembly 40. An insulating gasket top 66 is positioned at the locus where the side wall 62 of insulating gasket 60 extends from between the side walls 30 and 47 adjacent the top of the cell.

The outer surface 68 of the cell 10 is thus defined by portions of the outer surface of the top of the anode can 24, outer surface 58 of the side wall 47 of the cathode can 44, outer surface 50 of the bottom of the cathode can 44, and the top 66 of the insulating gasket 60.

The insulating gasket may also provide electrical insulation, preventing all effective direct electrical contact between the anode can 24 and the cathode can 44. Accordingly, the side wall 62 of the insulating gasket must circumscribe, and provide electrical insulation properties about, the entirety of the circumference of the battery between outer surface and inner surface 56, generally from the top of side wall 47 to the bottom of side wall 30. Similarly, the foot 64 of the insulating gasket must circumscribe, and provide electrical insulation properties about, the entirety of the circumference of the cell between foot 36 of side wall 30, the lower portion of side wall 47, and the outer perimeter portion of the cathode can assembly 40. The combination of good liquid sealing properties and good electrical insulation properties is typically achieved by molding known battery-grade nylon polymeric material in the desired configuration.

In order to meet the electrical insulation requirements, the insulating gasket may have good dielectric insulation properties, may have a minimum thickness about side wall 62, and may be free of any pinholes or other imperfections that might permit transmission of electric current between side walls 30 and 47. Thickness for the insulating gasket side wall 62 of about 200 to about 250 microns are common in conventional electrochemical cells. Thickness as thin as 100 microns are acceptable for cells of the disclosure, using the same resiliently deformable thermoplastic nylon material as the thicker insulating gaskets of the conventional art.

Depending on the structure of the battery to which the insulating gasket is to be applied, intermediate thicknesses such as, e.g., 150 microns, 140 microns, 127 microns, or the like, may be selected for some cells. However, where cell volume efficiency is a driving consideration, preferred thicknesses are less, for example 120 microns or 110 microns to as thin as 100 microns. Thus, the range of thicknesses for insulating gaskets 60 preferred for use in cells 10 of the disclosure has a lower end of about 100 microns.

In some embodiments, porous diffusion layer 57 is a microporous hydrophobic polymeric material such as a polytetrafluoroethylene (PTFE) membrane about 25 to about 100 microns thick, which permits passage of air through and which is generally impervious to battery electrolyte. In some embodiments, the porous diffusion layer 57 is Teflon™. In some embodiments, the porous diffusion layer 57, in combination with the air ports 54, is used to efficiently transport oxygen to the active reaction surface area of the cathode assembly.

In some embodiments, the cellulose air diffusion layer 32 is located underneath the porous diffusion layer 57 and acts as a protective lateral air diffusion layer. Specifically, when the cell is activated, the anode can assembly 22 presses down on the separator 74 and the cellulose air diffusion layer 32 helps to protect the air ports 54 from being completely covered.

In some embodiments, active layer 72 further includes a connecting substratum, namely a conductive woven nickel wire layer (not shown), capable of interfacing, as a current collector, with the cathode can. In some embodiments, carbon forms a matrix surrounding the conductive layer of nickel wire. In some embodiments, nickel is used for the conductive layer because nickel exhibits little or no corrosion in the environment of the metal air cell, and also because nickel is an excellent electrical conductor. In some embodiments, the thickness of the cathode assembly between the separator 74 and the porous diffusion layer 57 is as small as possible.

With the exceptions detailed in the present disclosure, the various components of the electrochemical cell may, in general, be prepared of materials, and using techniques, generally known in the art.

In another embodiment, the metal-air battery may be prepared by any means known in the art, so long as the resulting battery does not conflict with the disclosures presented herein. Thus, the present disclosure includes a method of preparing a metal-air battery including the components and their respective concentrations as discussed throughout the entirety of this disclosure.

The present invention, thus generally described, will be understood more readily by reference to the following examples, which are provided by way of illustration and are not intended to be limiting of the present invention.

### EXAMPLES

In the following examples, zinc-air battery cells were prepared and tested.
Example 1: Preparation of control electrolyte. For the control electrolyte preparation, 100 lbs KOH was diluted with de-ionized water to adjust the KOH concentration to about 40%. 1000 ppm of a cross-linked polyacrylic acid based gelling agent (ETD) and 15,000 ppm lithium hydroxide monohydrate were added to and mixed with the KOH to obtain the control electrolyte.
Example 2: Preparation of the surfactant containing electrolyte. For the surface-modifying surfactant containing electrolyte preparation included, 100 g KOH was diluted with de-ionized water to adjust the KOH concentration to about 32%. An appropriate amount of the surface modifying electrolyte, 1000 ppm of a cross-linked polyacrylic acid based gelling agent (ETD) and 15,000 ppm lithium hydroxide monohydrate were added to and mixed with the KOH to complete the process. Various surface-modifying and regular surfactants were tested as summarized in Table 1 below:

| Surfactant | Molecular weight |
|---|---|
| Polyethylene glycol | 20,000 |
| | 300 |
| Methyl polyethylene glycol | 550 |
| Capstone ® FS-50 | |
| cetyltrimethylammonium | 365 |
| bromide (CTAB) | |
| Sodium dodecyl | 77 |
| benzenesulfonate (SDBS) | |
| Sodium dodecyl sulfate (SDS) | 288 |
| Sodium hexametaphosphate | 612 |
| (SHMP) | |

Example 3: Preparation of the control battery cell. A control cell was prepared having a control electrolyte as described in Example 1. In the anode preparation step, Zn—Pb—In—Al alloy (98 wt %), a cross-linked polyacrylic acid based gelling agent (0.3 wt %), clay additive (0.2 wt %) and indium/lithium hydroxide (0.3 wt %) mixed in an erweka. De-ionized water was added during zinc mixing to coat the additive powders onto the zinc powder. The coated zinc is dried for 24 h at room temperature (20 °C). The dried additive coated zinc was then blended with an equal amount of uncoated zinc containing Teflon™ powder (0.02 wt %). The finished zinc is sieved through 2 sieve screens. Concentrations are specified based on the total zinc weight in the anode. During cell assembly, the blended zinc was dispensed into the anode can cavity followed by the electrolyte in set proportions which was varied as per the cell size.
Example 4: Preparation of battery cell with electrolyte containing a surface-modifying surfactant. A cell was prepared having the electrolyte for each of the surface-modifying surfactant as described in Examples 2, and using the anode preparation as described in Example 3. During cell assembly, the blended zinc was dispensed into the anode can cavity followed by the electrolyte in set proportions which was varied as per the cell size.
Example 5: Battery testing. In the Examples presented below, zinc-air cells prepared according to the present technology were tested under the hearing aid standard and wireless streaming discharge tests, using the following test protocols:

Measurement of battery performance under Hearing Aid Standard test protocols. Electrochemical cells may be tested in accordance with several methods under the American National Standards Institute (ANSI) testing standards. For primary hearing aid batteries using aqueous electrolytes, a pair of ANSI tests known as the hearing aid standard and wireless streaming tests determine cell performance and longevity. Hearing aid standard test involves applying a constant current load of 5 mA for 15 min followed by a 3 mA load for 45 min, thereafter followed by a 12 hour rest period. The daily cycle is 12 h on load followed by 12 h off load (or under rest period). The cycle is repeated until the cell operating voltage drops below 1.05 V. The second test involves alternating between a 12 mA 2 h load and a 3 mA 2 h load for a total of 12 h and a subsequent of a 12 h rest period. The (12 h ON/12 h OFF) load cycle continues until the cell running voltage drops below 1.1 V. Both tests were conducted at 4 months at room temperature to test long-term stability.

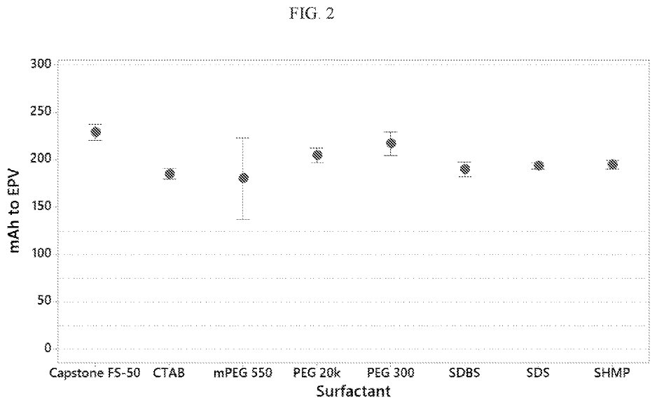

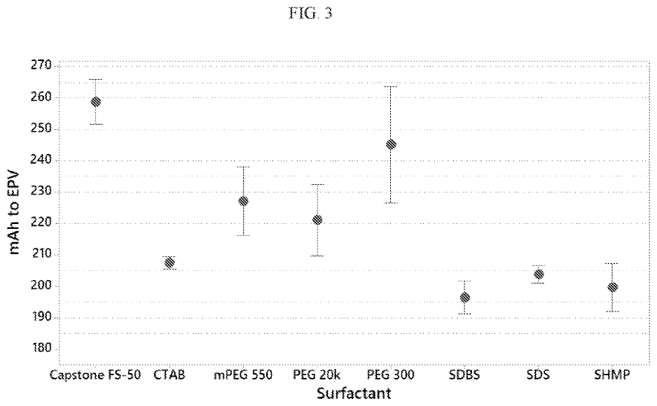

The interval plot of capacity (mAh) to the end point voltage (EPV) was noted for each of the tested surfactant and the results are depicted in FIGS. 2 and 3. These figures provide a comparison of the performance tests of electrolytes containing a surface-modifying surfactant against that of a conventional electrolyte containing commonly used surfactants on the hearing aid standard and wireless streaming pulse tests, respectively. The cells with surface-modifying surfactant clearly exhibit superior discharge capacity.

While certain embodiments have been illustrated and described, it should be understood that changes and modifications can be made therein in accordance with ordinary skill in the art without departing from the technology in its broader aspects as defined in the following claims.

The embodiments, illustratively described herein may suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

The present disclosure is not to be limited in terms of the particular embodiments described in this application. Many modifications and variations can be made without departing from its spirit and scope, as will be apparent to those skilled in the art. Functionally equivalent methods and compositions within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions or biological systems, which can of course vary. It is also to be understood that the terminology used herein is for the purpose of describing particular embodiments only, and is not intended to be limiting.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

Other embodiments are set forth in the following claims.

1. A metal-air battery comprising:
an air cathode;
a metal anode; and
an electrolyte comprising a surface-modifying surfactant;
wherein the surface-modifying surfactant comprises a polyethylene glycol (PEG), a mono-alkyl polyethylene glycol or a combination thereof.

2. The metal-air battery of claim 1, wherein the surface-modifying surfactant comprises polyethylene glycol.

3. The metal-air battery of claim 1, wherein the alkyl of the mono-alkyl polyethylene glycol is methyl, ethyl, propyl, n-butyl, or hexyl.

4. The metal-air battery of claim 1, wherein the surface-modifying surfactant comprises methyl-polyethylene glycol (mPEG).

5. The metal-air battery of claim 1, wherein the electrolyte comprises from about 10 ppm to about 15,000 ppm of the surface-modifying surfactant.

6. The metal-air battery of claim 1, wherein the electrolyte further comprises a gas-suppressant additive.

7. The metal-air battery of claim 6, wherein the gas-suppressant additive comprises lithium hydroxide, calcium hydroxide, aluminum hydroxide, zinc oxide, lead acetate, bismuth oxide, or a combination of any two or more thereof.

8. (canceled)

9. The metal-air battery of claim 6, wherein the electrolyte comprises from about 1,000 ppm to about 30,000 ppm of the gas-suppressant additive.

10. The metal-air battery of claim 1, wherein the electrolyte further comprises an amphoteric fluorosurfactant selected from CHEMGUARD® S-111, CHEMGUARD® S-500, CAPSTONE® FS-50, CAPSTONE® FS-51, APFS-14, DYNAX DX3001, ZONYL® FSK, ZONYL® FS-500, or a combination of any two or more thereof.

11. The metal-air battery of claim 10, wherein the electrolyte comprises from about 10 ppm to about 30,000 ppm of the amphoteric fluorosurfactant.

12. The metal-air battery of claim 1, wherein the electrolyte further comprises an additional surfactant comprising cetyltrimethylammonium bromide (CTAB), sodium dodecylbenzene sulfonate (SDBS), sodium dodecyl sulfate (SDS), Sodium hexametaphosphate (SHMP), lauryltrimethylammonium bromide, dodecyltrimethylammonium bromide, octyltrimethylammonium bromide, to polyethylene glycol methyl ether, polypropylene methyl ether, and polypropylene ethyl ether, or a combination of any two or more thereof.

13. The metal-air battery of claim 12, wherein the electrolyte comprises from about 10 ppm to about 15,000 ppm of the additional surfactant.

14. The metal-air battery of claim 1, wherein the electrolyte further comprises a corrosion inhibitor, a gelling agent, zinc oxide, potassium hydroxide, sodium hydroxide, polyacrylate polymer, or a combination of any two or more thereof.

15. The metal-air battery of claim 1 further comprising a separator between the air cathode and the metal anode.

16. The metal-air battery of claim 1, wherein the metal of the metal anode comprises zinc, lithium, aluminum, iron, magnesium, or alloys thereof.

17. An electrolyte comprising a surface-modifying surfactant and a gas-suppressant additive.

18. The electrolyte of claim 17, wherein the surface-modifying surfactant comprises a polyethylene glycol (PEG) or a mono-alkyl polyethylene glycol.

19. The electrolyte of claim 17, wherein the electrolyte comprises from about 10 ppm to about 15,000 ppm of the surface-modifying surfactant.

20. The electrolyte of claim 17, wherein the gas-suppressant additive comprises lithium hydroxide, calcium hydroxide, aluminum hydroxide, zinc oxide, lead acetate, bismuth oxide, or a combination of any two or more thereof.

21. The electrolyte of claim 20, wherein the electrolyte comprises from about 1,000 ppm to about 30,000 ppm of the gas-suppressant additive.
